(19) United States
(12) Patent Application Publication
(10) Pub. No.: US 2022/0127499 A1
(43) Pub. Date: Apr. 28, 2022

(54) Laminate Structure

(71) Applicant: Ticona LLC, Florence, KY (US)

(72) Inventor: Young Shin Kim, Cincinnati, OH (US)

(21) Appl. No.: 17/495,891

(22) Filed: Oct. 7, 2021

Related U.S. Application Data
(60) Provisional application No. 63/105,444, filed on Oct. 26, 2020.

(51) Int. Cl. C09J 7/29; B32B 7/12; C08L 67/04; C09J 5/06; C09J 7/38; C09J 7/35

(52) U.S. Cl. CPC C09J 7/29; C09J 2455/00; C08L 67/04; C09J 5/06; C09J 7/38; C09J 7/35; B32B 2305/55; B32B 2305/30; B32B 2457/00; C09J 2400/283; C09J 2400/243; C09J 2301/304; C09J 2301/302; C08L 2203/20; C09J 2463/00; B32B 7/12

(57) ABSTRACT

A laminate structure comprising a tape and a molded component is provided. The tape comprises a substrate having a first surface and an opposing second surface, wherein a first adhesive coating is disposed on the first surface of the substrate. The molded component is positioned adjacent and bonded to the first adhesive coating of the tape, wherein the molded component includes a polymer composition that contains a liquid crystalline polymer. The peel strength between the tape and the molded component is about 0.55 pounds-force per inch more as determined in accordance with ASTM D3167-10 (2017).

### CROSS REFERENCE TO RELATED APPLICATION

The present application claims filing benefit of U.S. Provisional Patent Application Ser. No. 63/105,444 having a filing date of Oct. 26, 2020, which is incorporated herein by reference in its entirety.

### BACKGROUND OF THE INVENTION

Antenna structures are often mounted within an electronic device so that radio-frequency signals can be transmitted and received through a dielectric structure, such as a housing or a transparent display cover (e.g., glass). To form the antenna structure, conductive elements or pathways are typically formed on a molded plastic component. It is becoming increasingly popular to form such pathways using a laser direct structuring (“LDS”) process during which a computer-controlled laser beam travels over the molded component to activate its surface at locations where the conductive path is to be situated. To help ensure that such antenna structures are securely retained within the electronic device, an adhesive tape may be interposed between the antenna structure and the inner surface of another component of the device, such as the display cover or housing. Unfortunately, one problem routinely encountered is that the bonding strength between the tape and the molded component is often poor, which can lead to problems during manufacturing and/or use of the electronic device. As such, a need currently exists for an improved technique for bonding a molded component (e.g., antenna structure) to other components of an electronic device.

### SUMMARY OF THE INVENTION

In accordance with one embodiment of the present invention, a laminate structure is disclosed that comprises a tape and a molded component. The tape comprises a substrate having a first surface and an opposing second surface, wherein a first adhesive coating is disposed on the first surface of the substrate. The molded component is positioned adjacent and bonded to the first adhesive coating of the tape. The molded component includes a polymer composition that contains a liquid crystalline polymer. The peel strength between the tape and the molded component is about 0.55 pounds-force per inch more as determined in accordance with ASTM D3167-10 (2017).

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a perspective view of one embodiment of an electronic device that may be formed in accordance with the present invention;

FIG. 2 is a perspective view of another embodiment of an electronic device that may be formed in accordance with the present invention;

FIG. 3 is a cross-sectional side view of a portion of an electronic device that contains a laminate formed by a molded component and tape in accordance with the present invention; and

FIG. 4 is a perspective view of a camera module that may be formed in accordance with one embodiment of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a laminate structure that contains a molded component bonded to a tape. The molded component contains a polymer composition that includes a liquid crystalline polymer. The tape contains an adhesive coating disposed on at least one surface of a substrate (e.g., film, paper, nonwoven web, etc.), which is positioned adjacent to and bonded to the molded component. For example, the substrate may define a first surface (e.g., upper surface) on which is disposed a first adhesive coating that is bonded to the molded component. The substrate may also define an opposing second surface (e.g., lower surface) on which a second adhesive coating is optionally disposed for bonding to another component. Regardless, by selectively controlling the components used to form the polymer composition of the molded component, the present inventor has discovered that resulting laminate can exhibit a high degree of peel strength. For example, the peel strength may be about 0.55 pounds-force per inch more, in some embodiments about 0.60 pounds-force per inch or more, in some embodiments about 0.65 pounds-force per inch or more, and in some embodiments, from about 0.70 pounds-force per inch to about 1 pound-force per inch, as determined in accordance with ASTM D3167-10 (2017). The peak strength may likewise be about 0.55 pounds-force per inch more, in some embodiments about 0.80 pounds-force per inch or more, in some embodiments about 0.9 pounds-force per inch or more, and in some embodiments, from about 1 pound-force per inch to about 5 pounds-force per inch, as determined in accordance with ASTM D3167-10 (2017).

Not only is the laminate structure capable of exhibiting a high degree of peel strength, it is also capable of doing so while still maintaining excellent thermal and mechanical properties to enable its use in a wide variety of applications. For example, the melting temperature of the polymer composition may be about 200° C. to about 400° C., in some embodiments from about 250° C. to about 380° C., in some embodiments from about 270° C. to about 360° C., and in some embodiments from about 280° C. to about 325° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments from about 0.65 to about 0.85. The specific DTUL values may, for instance, be about 160° C. or more, in some embodiments from about 170° C. to about 280° C., in some embodiments from about 180° C. to about 260° C., and in some embodiments from about 190° C. to about 240° C., as determined in accordance with ISO Test No. 75-2:2013 at a load of 1.8 Megapascals. Such high DTUL values can, among other things, allow the use of high speed and reliable surface mounting processes to help bond the molded component to the tape.

The polymer composition (and molded component) may also possess excellent mechanical properties. For example, the polymer composition (and molded component) may exhibit a tensile strength of about 10 MPa or more, in some embodiments about 50 MPa or more, in some embodiments from about 70 MPa to about 300 MPa, and in some embodiments from about 80 MPa to about 200 MPa. The polymer composition (and molded component) may exhibit a tensile elongation of about 0.5% or more, in some embodiments from about 1% to about 10%, and in some embodiments from about 2% to about 8%. The polymer composition (and molded component) may exhibit a tensile modulus of about 5,000 MPa or more, in some embodiments about 6,000 MPa or more, in some embodiments about 7,000 MPa to about 25,000 MPa, and in some embodiments from about 10,000 MPa to about 20,000 MPa. The tensile properties may be determined at a temperature of 23° C. in accordance with ISO Test No. 527:2012. Also, the polymer composition (and molded component) may exhibit a flexural strength of about 20 MPa or more, in some embodiments about 30 MPa or more, in some embodiments about 50 MPa or more, in some embodiments from about 70 MPa to about 300 MPa, and in some embodiments from about 80 MPa to about 200 MPa. The polymer composition (and molded component) may exhibit a flexural elongation of about 0.4% or more, in some embodiments from about 0.5% to about 4%, and in some embodiments from about 0.5% to about 2%. The polymer composition (and molded component) may exhibit a flexural modulus of about 5,000 MPa or more, in some embodiments about 6,000 MPa or more, in some embodiments about 7,000 MPa to about 25,000 MPa, and in some embodiments from about 10,000 MPa to about 20,000 MPa. The flexural properties may be determined at a temperature of 23° C. in accordance with 178:2010. Furthermore, the polymer composition (and molded component) may also possess a high impact strength, which may be useful when forming thin laminate structures. The Charpy notched impact strength may, for instance, be about 3 kJ/m² or more, in some embodiments about 5 kJ/m² or more, in some embodiments about 7 kJ/m² or more, in some embodiments from about 8 kJ/m² to about 40 kJ/m², and in some embodiments from about 10 kJ/m² to about 25 kJ/m². The impact strength may be determined at a temperature of 23° C. in accordance with ISO Test No. ISO 179-1:2010.

Various embodiments of the present invention will now be described in more detail.

I. Polymer Composition

A. Liquid Crystalline Polymer

The polymer composition generally contains one or more liquid crystalline polymers. Liquid crystalline polymers are generally classified as “thermotropic” to the extent that they can possess a rod-like structure and exhibit a crystalline behavior in their molten state (e.g., thermotropic nematic state). The liquid crystalline polymers employed in the polymer composition typically have a melting temperature of from about 200° C. to about 400° C., in some embodiments from about 250° C. to about 380° C., in some embodiments from about 270° C. to about 360° C., and in some embodiments from about 280° C. to about 325° C. The melting temperature may be determined as is well known in the art using differential scanning calorimetry (“DSC”), such as determined by ISO Test No. 11357-3:2011. Such polymers may be formed from one or more types of repeating units as is known in the art. A liquid crystalline polymer may, for example, contain one or more aromatic ester repeating units generally represented by the following Formula (I):

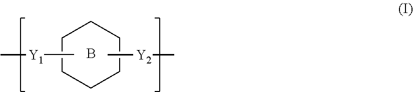

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic hydroxycarboxylic repeating units, for instance, may be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute about 50 mol. % or more, in some embodiments about 60 mol. % or more, and in some embodiments, from about 80 mol. % to 100 mol. % of the polymer.

Aromatic dicarboxylic repeating units may also be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 1 mol. % to about 50 mol. %, in some embodiments from about 2 mol. % to about 40 mol. %, and in some embodiments, from about 5 mol. % to about 30% of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 30 mol. %, in some embodiments from about 2 mol. % to about 25 mol. %, and in some embodiments, from about 5 mol. % to about 20% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

Although not necessarily required, the liquid crystalline polymer may be a “high naphthenic” polymer to the extent that it contains a relatively high content of repeating units derived from naphthenic hydroxycarboxylic acids and naphthenic dicarboxylic acids, such as NDA, HNA, or combinations thereof. That is, the total amount of repeating units derived from naphthenic hydroxycarboxylic and/or dicarboxylic acids (e.g., NDA, HNA, or a combination of HNA and NDA) is typically about 5 mol. % or more, in some embodiments from about 10 mol. % to about 40 mol. %, and in some embodiments, from about 15 mol. % to about 30 mol. % of the polymer. Contrary to many conventional “low naphthenic” polymers, it is believed that the resulting “high naphthenic” polymers are capable of exhibiting good thermal and mechanical properties.

In one particular embodiment, for instance, the liquid crystalline polymer may contain repeating units derived from HNA in an amount from 5 mol. % to about 50 mol. %, in some embodiments from about 10 mol. % to about 40 mol. %, and in some embodiments, from about 15 mol. % to about 30 mol. %. The liquid crystalline polymer may also contain various other monomers. For example, the polymer may contain repeating units derived from HBA in an amount of from about 50 mol. % to about 95 mol. %, and in some embodiments from about 60 mol. % to about 90 mol. %, and in some embodiments, from about 65 mol. % to about 85 mol. %. When employed, the molar ratio of repeating units derived from HBA to the repeating units derived from HNA may be selectively controlled within a specific range to help achieve the desired properties, such as from about 0.5 to about 20, in some embodiments from about 1 to about 10, and in some embodiments, from about 2 to about 6. The polymer may also contain repeating units derived from aromatic dicarboxylic acid(s) (e.g., IA and/or TA) in an amount of from about 0.1 mol. % to about 20 mol. %, and in some embodiments, from about 0.2 mol. % to about 10 mol. %; and/or aromatic diol(s) (e.g., BP and/or HQ) in an amount of from about 0.1 mol. % to about 20 mol. %, and in some embodiments, from about 0.2 mol. % to about 10 mol. %. In some cases, however, it may be desired to minimize the presence of such monomers in the polymer to help achieve the desired properties. For example, the total amount of repeating units derived from aromatic dicarboxylic acid(s) (e.g., IA and/or TA) and/or aromatic diols (e.g., BP and/or HQ) may be about 5 mol % or less, in some embodiments about 4 mol. % or less, and in some embodiments, from about 0.1 mol. % to about 3 mol. %, of the polymer.

Regardless of the particular constituents and nature of the polymer, the liquid crystalline polymer may be prepared by initially introducing the aromatic monomer(s) used to form the ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, Ill., et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 200° C. to about 400° C. For instance, one suitable technique for forming the aromatic polyester may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 200° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 200° C. to about 400° C. The polymerization time will of course vary based on the temperature and target molecular weight. In most cases, however, the solid-state polymerization time will be from about 2 to about 12 hours, and in some embodiments, from about 4 to about 10 hours.

Generally speaking, the total amount of liquid crystalline polymers employed in the polymer composition is from about 40 wt. % to about 90 wt. %, in some embodiments, from about 45 wt. % to about 85 wt. %, and in some embodiments, from about 50 wt. % to about 80 wt. % of the polymer composition. In certain embodiments, all of the liquid crystalline polymers are “high naphthenic” polymers such as described above. In other embodiments, however, “low naphthenic” liquid crystalline polymers may also be employed in the composition in which the total amount of repeating units derived from naphthenic hydroxycarboxylic and/or dicarboxylic acids (e.g., NDA, HNA, or a combination of HNA and NDA) is less than 10 mol. %, in some embodiments about 8 mol. % or less, in some embodiments about 6 mol. % or less, and in some embodiments, from about 1 mol. % to about 5 mol. % of the polymer. When employed, it is generally desired that such low naphthenic polymers are present in only a relatively low amount. For example, when employed, low naphthenic liquid crystalline polymers typically constitute from about 1 wt. % to about 50 wt. %, in some embodiments from about 10 wt. % to about 45 wt. %, and in some embodiments, from about 20 wt. % to about 40 wt. % of the total amount of liquid crystalline polymers in the composition, and from about 0.5 wt. % to about 45 wt. %, in some embodiments from about 2 wt. % to about 35 wt. %, and in some embodiments, from about 5 wt. % to about 25 wt. % of the entire composition. Conversely, high naphthenic liquid crystalline polymers typically constitute from about 50 wt. % to about 99 wt. %, in some embodiments from about 55 wt. % to about 95 wt. %, and in some embodiments, from about 60 wt. % to about 90 wt. % of the total amount of liquid crystalline polymers in the composition, and from about 25 wt. % to about 65 wt. %, in some embodiments from about 30 wt. % to about 60 wt. %, and in some embodiments, from about 35 wt. % to about 55 wt. % of the entire composition.

B. Optional Additives

i. Compatibilizer

If desired, a compatibilizer may be employed in the polymer composition to help further improve adhesion of the molded component to the tape. When employed, such compatibilizers typically constitute from about 0.1 wt. % to about 15 wt. %, in some embodiments from about 0.2 wt. % to about 12 wt. %, and in some embodiments, from about 0.5 wt. % to about 10 wt. % of the polymer composition.

One particularly suitable type of compatibilizer may include, for instance, an olefin copolymer that is “epoxy-functionalized” in that it contains, on average, two or more epoxy functional groups per molecule. The copolymer generally contains an olefinic monomeric unit that is derived from one or more α-olefins. Examples of such monomers include, for instance, linear and/or branched α-olefins having from 2 to 20 carbon atoms and typically from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin monomers are ethylene and propylene. The copolymer may also contain an epoxy-functional monomeric unit. One example of such a unit is an epoxy-functional (meth)acrylic monomeric component. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight.

Of course, the copolymer may also contain other monomeric units as is known in the art. For example, another suitable monomer may include a (meth)acrylic monomer that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one particular embodiment, for example, the copolymer may be a terpolymer formed from an epoxy-functional (meth)acrylic monomeric component, α-olefin monomeric component, and non-epoxy functional (meth)acrylic monomeric component. The copolymer may, for instance, be poly(ethylene-co-butylacrylate-co-glycidyl methacrylate), which has the following structure:

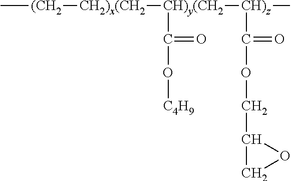

wherein, x, y, and z are 1 or greater.

The relative portion of the monomeric component(s) may be selected to achieve a balance between epoxy-reactivity and melt flow rate. More particularly, high epoxy monomer contents can result in good reactivity with the matrix polymer, but too high of a content may reduce the melt flow rate to such an extent that the copolymer adversely impacts the melt strength of the polymer blend. Thus, in most embodiments, the epoxy-functional (meth)acrylic monomer(s) constitute from about 1 wt. % to about 20 wt. %, in some embodiments from about 2 wt. % to about 15 wt. %, and in some embodiments, from about 3 wt. % to about 10 wt. % of the copolymer. The α-olefin monomer(s) may likewise constitute from about 55 wt. % to about 95 wt. %, in some embodiments from about 60 wt. % to about 90 wt. %, and in some embodiments, from about 65 wt. % to about 85 wt. % of the copolymer. When employed, other monomeric components (e.g., non-epoxy functional (meth)acrylic monomers) may constitute from about 5 wt. % to about 35 wt. %, in some embodiments from about 8 wt. % to about 30 wt. %, and in some embodiments, from about 10 wt. % to about 25 wt. % of the copolymer. The resulting melt flow rate is typically from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-13 at a load of 2.16 kg and temperature of 190° C.

One example of a suitable epoxy-functionalized olefin copolymer that may be used in the polymer composition is commercially available from Arkema under the name LOTADER® AX8840. LOTADER® AX8840, for instance, has a melt flow rate of 5 g/10 min and has a glycidyl methacrylate monomer content of 8 wt. %. Another suitable copolymer is commercially available from DuPont under the name ELVALOY® PTW, which is a terpolymer of ethylene, butyl acrylate, and glycidyl methacrylate and has a melt flow rate of 12 g/10 min and a glycidyl methacrylate monomer content of 4 wt. % to 5 wt. %.

ii. Mineral Filler

If desired, the polymer composition may contain one or more mineral fillers distributed within the polymer matrix. When employed, such mineral filler(s) typically constitute from about 5 wt. % to about 50 wt. %, in some embodiments from about 10 wt. % to about 45 wt. %, and in some embodiments, from about 20 wt. % to about 40 wt. % of the polymer composition. The nature of the mineral filler(s) employed in the polymer composition may vary, such as mineral particles, mineral fibers (or “whiskers”), etc., as well as blends thereof. Typically, the mineral filler(s) employed in the polymer composition have a certain hardness value to help improve the mechanical strength, adhesive strength, and surface properties of the composition. For instance, the hardness values may be about 2.0 or more, in some embodiments about 2.5 or more, in some embodiments about 3.0 or more, in some embodiments from about 3.0 to about 11.0, in some embodiments from about 3.5 to about 11.0, and in some embodiments, from about 4.5 to about 6.5 based on the Mohs hardness scale.

Any of a variety of different types of mineral particles may generally be employed in the polymer composition, such as those formed from a natural and/or synthetic silicate mineral, such as talc, mica, silica (e.g., amorphous silica), alumina, halloysite, kaolinite, illite, montmorillonite, vermiculite, palygorskite, pyrophyllite, calcium silicate, aluminum silicate, wollastonite, etc.; sulfates; carbonates; phosphates; fluorides, borates; and so forth. Particularly suitable are particles having the desired hardness value, such as calcium carbonate (CaCO₃, Mohs hardness of 3.0), copper carbonate hydroxide (Cu₂CO₃(OH)₂, Mohs hardness of 4.0); calcium fluoride (CaFl₂, Mohs hardness of 4.0); calcium pyrophosphate ((Ca₂P₂O₇, Mohs hardness of 5.0), anhydrous dicalcium phosphate (CaHPO₄, Mohs hardness of 3.5), hydrated aluminum phosphate (AlPO₄.2H₂O, Mohs hardness of 4.5); silica (SiO₂, Mohs hardness of 5.0-6.0), potassium aluminum silicate (KAlSi₃O₈, Mohs hardness of 6), copper silicate (CuSiO₃.H₂O, Mohs hardness of 5.0); calcium borosilicate hydroxide (Ca₂B₅SiO₉(OH)₅, Mohs hardness of 3.5); alumina (AlO₂, Mohs hardness of 10.0); calcium sulfate (CaSO₄, Mohs hardness of 3.5), barium sulfate (BaSO₄, Mohs hardness of from 3 to 3.5), mica (Mohs hardness of 2.5-5.3), and so forth, as well as combinations thereof. Mica, for instance, is particularly suitable. Any form of mica may generally be employed, including, for instance, muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃ (AlSi₃)O₁₀(OH)₂), glauconite (K,Na)(Al,Mg,Fe)₂(Si,Al)₄O₁₀(OH)₂), etc. Muscovite-based mica is particularly suitable for use in the polymer composition.

In certain embodiments, the mineral particles, such as barium sulfate and/or calcium sulfate particles, may have a shape that is generally granular or nodular in nature. In such embodiments, the particles may have a median size (e.g., diameter) of from about 0.5 to about 20 micrometers, in some embodiments from about 1 to about 15 micrometers, in some embodiments from about 1.5 to about 10 micrometers, and in some embodiments, from about 2 to about 8 micrometers, such as determined using laser diffraction techniques in accordance with ISO 13320:2009 (e.g., with a Horiba LA-960 particle size distribution analyzer). In other embodiments, it may also be desirable to employ flake-shaped mineral particles, such as mica particles, that have a relatively high aspect ratio (e.g., average diameter divided by average thickness), such as about 4 or more, in some embodiments about 8 or more, and in some embodiments, from about 10 to about 500. In such embodiments, the average diameter of the particles may, for example, range from about 5 micrometers to about 200 micrometers, in some embodiments from about 8 micrometers to about 150 micrometers, and in some embodiments, from about 10 micrometers to about 100 micrometers. The average thickness may likewise be about 2 micrometers or less, in some embodiments from about 5 nanometers to about 1 micrometer, and in some embodiments, from about 20 nanometers to about 500 nanometers such as determined using laser diffraction techniques in accordance with ISO 13320:2009 (e.g., with a Horiba LA-960 particle size distribution analyzer). The mineral particles may also have a narrow size distribution. That is, at least about 70% by volume of the particles, in some embodiments at least about 80% by volume of the particles, and in some embodiments, at least about 90% by volume of the particles may have a size within the ranges noted above.

Suitable mineral fibers may likewise include those that are derived from silicates, such as neosilicates, sorosilicates, inosilicates (e.g., calcium inosilicates, such as wollastonite; calcium magnesium inosilicates, such as tremolite; calcium magnesium iron inosilicates, such as actinolite; magnesium iron inosilicates, such as anthophyllite; etc.), phyllosilicates (e.g., aluminum phyllosilicates, such as palygorskite), tectosilicates, etc.; sulfates, such as calcium sulfates (e.g., dehydrated or anhydrous gypsum); mineral wools (e.g., rock or slag wool); and so forth. Particularly suitable are fibers having the desired hardness value, including fibers derived from inosilicates, such as wollastonite (Mohs hardness of 4.5 to 5.0), which are commercially available from Nyco Minerals under the trade designation Nyglos® (e.g., Nyglos® 4W or Nyglos® 8). The mineral fibers may have a median width (e.g., diameter) of from about 1 to about 35 micrometers, in some embodiments from about 2 to about 20 micrometers, in some embodiments from about 3 to about 15 micrometers, and in some embodiments, from about 7 to about 12 micrometers. The mineral fibers may also have a narrow size distribution. That is, at least about 60% by volume of the fibers, in some embodiments at least about 70% by volume of the fibers, and in some embodiments, at least about 80% by volume of the fibers may have a size within the ranges noted above. Without intending to be limited by theory, it is believed that mineral fibers having the size characteristics noted above can more readily move through molding equipment, which enhances the distribution within the polymer matrix and minimizes the creation of surface defects. In addition to possessing the size characteristics noted above, the mineral fibers may also have a relatively high aspect ratio (average length divided by median width) to help further improve the mechanical properties and surface quality of the resulting polymer composition. For example, the mineral fibers may have an aspect ratio of from about 2 to about 100, in some embodiments from about 2 to about 50, in some embodiments from about 3 to about 20, and in some embodiments, from about 4 to about 15. The volume average length of such mineral fibers may, for example, range from about 1 to about 200 micrometers, in some embodiments from about 2 to about 150 micrometers, in some embodiments from about 5 to about 100 micrometers, and in some embodiments, from about 10 to about 50 micrometers.

iii. Laser Activatable Additive

Although by no means required, the polymer composition may be “laser activatable” in the sense that it contains an additive that can be activated by a laser direct structuring (“LDS”) process. In such a process, the additive is exposed to a laser that causes the release of metals. The laser thus draws the pattern of conductive elements onto the part and leaves behind a roughened surface containing embedded metal particles. These particles act as nuclei for the crystal growth during a subsequent plating process (e.g., copper plating, gold plating, nickel plating, silver plating, zinc plating, tin plating, etc.). The laser activatable additive generally includes oxide crystals, which may include two or more metal oxide cluster configurations within a definable crystal formation. For example, the overall crystal formation may have the following general formula:

AB₂O₄ or ABO₂

wherein,

A is a metal cation having a valance of 2 or more, such as cadmium, chromium, manganese, nickel, zinc, copper, cobalt, iron, magnesium, tin, titanium, etc., as well as combinations thereof; and

B is a metal cation having a valance of 3 or more, such as antimony, chromium, iron, aluminum, nickel, manganese, tin, etc., as well as combinations thereof.

Typically, A in the formula above provides the primary cation component of a first metal oxide cluster and B provides the primary cation component of a second metal oxide cluster. These oxide clusters may have the same or different structures. In one embodiment, for example, the first metal oxide cluster has a tetrahedral structure and the second metal oxide cluster has an octahedral cluster. Regardless, the clusters may together provide a singular identifiable crystal type structure having heightened susceptibility to electromagnetic radiation. Examples of suitable oxide crystals include, for instance, MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, tin/antimony oxides (e.g., (Sb/Sn)O₂), and combinations thereof. Copper chromium oxide (CuCr₂O₄) is particularly suitable for use in the present invention and is available from Shepherd Color Co. under the designation “Shepherd Black 1GM.” In some cases, the laser activatable additive may also have a core-shell configuration, such as described in WO 2018/130972. In such additives, the shell component of the additive is typically laser activatable, while the core may be any general compound, such as an inorganic compound (e.g., titanium dioxide, mica, talc, etc.).

When employed, laser activatable additives typically constitute from about 0.1 wt. % to about 30 wt. %, in some embodiments from about 0.5 wt. % to about 20 wt. %, and in some embodiments, from about 1 wt. % to about 10 wt. % of the polymer composition.

iv. Other Additives

A wide variety of other additional additives can also be included in the polymer composition, such as lubricants, thermally conductive fillers (e.g., carbon black, graphite, boron nitride, etc.), pigments, antioxidants, stabilizers, surfactants, waxes, flame retardants, anti-drip additives, nucleating agents (e.g., boron nitride), tribological agents (e.g., fluoropolymers), antistatic fillers (e.g., carbon black, carbon nanotubes, carbon fibers, graphite, ionic liquids, etc.), fibrous fillers (e.g., glass fibers, carbon fibers, etc.), and other materials added to enhance properties and processability. Lubricants, for example, may be employed in the polymer composition that are capable of withstanding the processing conditions of the liquid crystalline polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

C. Formation

The components used to form the polymer composition may be combined together using any of a variety of different techniques as is known in the art. In one particular embodiment, for example, the liquid crystalline polymer(s) and other optional additives are melt processed as a mixture within an extruder to form the polymer composition. The mixture may be melt-kneaded in a single-screw or multi-screw extruder at a temperature of from about 200° C. to about 450° C. In one embodiment, the mixture may be melt processed in an extruder that includes multiple temperature zones. The temperature of individual zones are typically set within about −60° C. to about 25° C. relative to the melting temperature of the polymer. By way of example, the mixture may be melt processed using a twin screw extruder such as a Leistritz 18-mm co-rotating fully intermeshing twin screw extruder. A general purpose screw design can be used to melt process the mixture. In one embodiment, the mixture including all of the components may be fed to the feed throat in the first barrel by means of a volumetric feeder. In another embodiment, different components may be added at different addition points in the extruder, as is known. For example, the polymer may be applied at the feed throat, and certain additives (e.g., mineral fillers, compatibilizers, etc.) may be supplied at the same or different temperature zone located downstream therefrom. Regardless, the resulting mixture can be melted and mixed then extruded through a die. The extruded polymer composition can then be quenched in a water bath to solidify and granulated in a pelletizer followed by drying.

Regardless of the manner in which the composition is formed, the resulting melt viscosity is generally low enough that it can readily form a melt-extruded substrate. For example, in one particular embodiment, the polymer composition may have a melt viscosity of about 500 Pa-s or less, in some embodiments about 250 Pa-s or less, in some embodiments from about 5 Pa-s to about 150 Pa-s, in some embodiments from about 5 Pa-s to about 100 Pa-s, in some embodiments from about 10 Pa-s to about 100 Pa-s, in some embodiments from about 15 to about 90 Pa-s, as determined at a shear rate of 1,000 seconds⁻¹.

II. Molded Component

The molded component may have a wide variety of thicknesses, such as about 10 millimeters or less, in some embodiments about 5 millimeters or less, and in some embodiments, from about 1 to about 4 millimeters (e.g., 3 millimeters). The molded component may also be formed using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

As indicated above, conductive elements may also be formed on the molded component. The conductive elements can form antennas of a variety of different types, such as antennae with resonating elements that are formed from patch antenna structures, inverted-F antenna structures, closed and open slot antenna structures, loop antenna structures, monopoles, dipoles, planar inverted-F antenna structures, hybrids of these designs, etc. If desired, the polymer composition employed in the molded component may be laser activatable so that the conductive elements can be formed using a laser direct structuring process (“LDS”). Activation with a laser causes a physio-chemical reaction in which the spinel crystals are cracked open to release metal atoms. These metal atoms can act as a nuclei for metallization (e.g., reductive copper coating). The laser also creates a microscopically irregular surface and ablates the polymer matrix, creating numerous microscopic pits and undercuts in which the copper can be anchored during metallization.

If desired, high frequency antennas and antenna arrays may be formed on the molded component for use in a 5G system. As used herein, “5G” generally refers to high speed data communication over radio frequency signals. 5G networks and systems are capable of communicating data at much faster rates than previous generations of data communication standards (e.g., “4G, “LTE”). For example, as used herein, “5G frequencies” can refer to frequencies that are 1.5 GHz or more, in some embodiments about 2.0 GHz or more, in some embodiments about 2.5 GHz or higher, in some embodiments about 3.0 GHz or higher, in some embodiments from about 3 GHz to about 300 GHz, or higher, in some embodiments from about 4 GHz to about 80 GHz, in some embodiments from about 5 GHz to about 80 GHz, in some embodiments from about 20 GHz to about 80 GHz, and in some embodiments from about 28 GHz to about 60 GHz. Various standards and specifications have been released quantifying the requirements of 5G communications. As one example, the International Telecommunications Union (ITU) released the International Mobile Telecommunications-2020 (“IMT-2020”) standard in 2015. The IMT-2020 standard specifies various data transmission criteria (e.g., downlink and uplink data rate, latency, etc.) for 5G. The IMT-2020 Standard defines uplink and downlink peak data rates as the minimum data rates for uploading and downloading data that a 5G system must support. The IMT-2020 standard sets the downlink peak data rate requirement as 20 Gbit/s and the uplink peak data rate as 10 Gbit/s. As another example, 3^{rd} Generation Partnership Project (3GPP) recently released new standards for 5G, referred to as “5G NR.” 3GPP published “Release 15” in 2018 defining “Phase 1” for standardization of 5G NR. 3GPP defines 5G frequency bands generally as “Frequency Range 1” (FR1) including sub-6 GHz frequencies and “Frequency Range 2” (FR2) as frequency bands ranging from 20-60 GHz. Antenna systems described herein can satisfy or qualify as “5G” under standards released by 3GPP, such as Release 15 (2018), and/or the IMT-2020 Standard.

To achieve high speed data communication at high frequencies, antenna elements and arrays may employ small feature sizes/spacing (e.g., fine pitch technology) that can improve antenna performance. For example, the feature size (spacing between antenna elements, width of antenna elements) etc. is generally dependent on the wavelength (“λ”) of the desired transmission and/or reception radio frequency propagating through the substrate dielectric on which the antenna element is formed (e.g., nλ/4 where n is an integer). Further, beamforming and/or beam steering can be employed to facilitate receiving and transmitting across multiple frequency ranges or channels (e.g., multiple-in-multiple-out (MIMO), massive MIMO).

The high frequency 5G antenna elements can have a variety of configurations. For example, the 5G antenna elements can be or include co-planar waveguide elements, patch arrays (e.g., mesh-grid patch arrays), other suitable 5G antenna configurations. The antenna elements can be configured to provide MIMO, massive MIMO functionality, beam steering, and the like. As used herein “massive” MIMO functionality generally refers to providing a large number transmission and receiving channels with an antenna array, for example 8 transmission (Tx) and 8 receive (Rx) channels (abbreviated as 8×8). Massive MIMO functionality may be provided with 8×8, 12×12, 16×16, 32×32, 64×64, or greater. The antenna elements can have a variety of configurations and arrangements and can be fabricated on the molded component using a variety of manufacturing techniques. As one example, the antenna elements and/or associated elements (e.g., ground elements, feed lines, etc.) can employ fine pitch technology. Fine pitch technology generally refers to small or fine spacing between their components or leads. For example, feature dimensions and/or spacing between antenna elements (or between an antenna element and a ground plane) can be about 1,500 micrometers or less, in some embodiments 1,250 micrometers or less, in some embodiments 750 micrometers or less (e.g., center-to-center spacing of 1.5 mm or less), 650 micrometers or less, in some embodiments 550 micrometers or less, in some embodiments 450 micrometers or less, in some embodiments 350 micrometers or less, in some embodiments 250 micrometers or less, in some embodiments 150 micrometers or less, in some embodiments 100 micrometers or less, and in some embodiments 50 micrometers or less. However, it should be understood that feature sizes and/or spacings that are smaller and/or larger may be employed. As a result of such small feature dimensions, antenna systems can be achieved with a large number of antenna elements on the molded component in a small footprint. For example, an antenna array can have an average antenna element concentration of greater than 1,000 antenna elements per square centimeter, in some embodiments greater than 2,000 antenna elements per square centimeter, in some embodiments greater than 3,000 antenna elements per square centimeter, in some embodiments greater than 4,000 antenna elements per square centimeter, in some embodiments greater than 6,000 antenna elements per square centimeter, and in some embodiments greater than about 8,000 antenna elements per square centimeter. Such compact arrangement of antenna elements can provide a greater number of channels for MIMO functionality per unit area of the antenna area. For example, the number of channels can correspond with (e.g., be equal to or proportional with) the number of antenna elements.

III. Tape

The tape employed in the laminate structure may be formed from any of a variety of materials as is known in the art. Typically, the tape includes a base substrate, such as a film, paper web, nonwoven web, foam, etc. The substrate may be relatively thin in nature, such as having a thickness of from about 1 μm to about 500 μm, in some embodiments from about 10 μm to about 300 μm, and in some embodiments, from about 20 to about 100 μm. An adhesive coating is also typically disposed on one or more surfaces of the tape for bonding to the molded component. For example, the substrate may define a first surface (e.g., upper surface) and an opposing second surface (e.g., lower surface). A first adhesive coating may be disposed on the first surface and a second adhesive coating may be disposed on the second surface such that the tape contains an adhesive on multiple surfaces. In this manner, the tape can help bond together the molded component with another component.

The nature of the adhesive coating(s) may vary as is known to those skilled in the art, such as a hot melt adhesive, pressure-sensitive adhesive, etc., as well as combinations thereof. The adhesive coatings used on different surfaces of the tape may also be the same or different in nature. Regardless, the adhesive coating(s) on the tape typically contain at least one thermoplastic polymer. In one embodiment, for example, an elastomeric thermoplastic polymer may be employed to provide the adhesive with “pressure-sensitive” bonding properties. Examples of such elastomeric polymers may include acrylate and/or methacrylate polymers, polyurethanes, natural rubber, synthetic rubbers (e.g., butyl, (iso)butyl, nitrile or butadiene rubbers), styrene block copolymers having an elastomer block composed of unsaturated or partly or fully hydrogenated polydiene blocks (e.g., polybutadiene, polyisoprene, poly(iso)butylene, etc.), polyolefins (e.g., ethylene vinyl acetate copolymers), fluoropolymers, silicones, and so forth, as well as combinations of such elastomers. Regardless of the exact polymer, it is typically desired that the glass transition temperature (Tg) of the thermoplastic elastomeric polymer is from about −40° C. to about 10° C., in some embodiments from about −30° C. to about 0° C., and in some embodiments, from about −25° C. to about −10° C. In one particular embodiment, for example, an acrylonitrile/butadiene copolymer elastomer may be employed (e.g., Nipol™ 1401LG, Tg=−18° C.). Other thermoplastic polymers may also be employed in addition to or in lieu of an elastomeric thermoplastic polymer, such as a polyolefin (e.g., polypropylene, polyethylene, etc.), polyvinyl chloride, polystyrene, polyoxymethylene, polyethylene oxide, polyethylene terephthalate, polycarbonate, polyphenylene oxides, polyurethanes, polyurea, acrylonitrile-butadiene-styrene, polyamides, polylactate, polyetheretherketone, polysulfone, polyethersulfone, and so forth, as well as combinations of such polymers.

In certain embodiments, the adhesive may also be a “hot-melt” adhesive in the sense that it is generally a solid at room temperature (23° C.) but can be rendered flowable after heating to a certain temperature. In this manner, the tape may be placed into contact with the molded component and/or other electronic components while in a stable, non-adhesive form, and thereafter heat activated to initiate the desired degree of bonding. The activation temperature may, for instance, range from about 80° C. to about 250° C., in some embodiments from about 100° C. to about 220° C., and in some embodiments, from about 110° C. to about 210° C. For pressure-sensitive, hot-melt adhesives, a certain degree of pressure may also be needed to ensure adequate bonding, such as from about 1 to about 50 bar, in some embodiments from about 2 to about 40 bar, and in some embodiments, from about 5 to about 30 bar, for a time period ranging from about 1 to about 500 seconds, in some embodiments from about 2 to about 350 seconds, and in some embodiments, from about 5 to about 180 seconds.

To help form such an adhesive, a reactive resin is typically employed. When employed, reactive resin(s) are generally present in an amount of from about 20 to about 800 parts, in some embodiments from about 50 to about 600 parts, and in some embodiments, from about 100 to about 500 parts by weight per 100 parts by weight of the thermoplastic polymer(s) employed in the adhesive coating. The reactive resin(s) may likewise constitute from about 30 wt. % to about 95 wt. %, in some embodiments from about 40 wt. % to about 90 wt. %, and in some embodiments, from about 50 wt. % to about 85 wt. %, based on the total solids content of the adhesive coating. The thermoplastic polymer(s), on the other hand, typically constitute from about 5 wt. % to about 70 wt. %, in some embodiments from about 10 wt. % to about 60 wt. %, and in some embodiments, from about 15 wt. % to about 50 wt. %, based on the total solids content of the adhesive coating.

Suitable reactive resins may include, for instance, polyesters, polyethers, polyurethanes, epoxy resins, phenolic resins, cresols or novolac resins, polysulfides, acrylic polymers (acrylic or methacrylic), and so forth, as well as combinations thereof. Epoxy resins are particularly suitable for use as a reactive resin in the adhesive coating. The epoxy equivalent weight of such resins may be from about 100 to about 1,000, in some embodiments from about 120 to about 800, and in some embodiments, from about 150 to about 600 grams per gram equivalent as determined in accordance with ASTM D1652-11e1. The epoxy resin also typically contains, on the average, at least about 1.3, in some embodiments from about 1.6 to about 8, and in some embodiments, from about 3 to about 5 epoxide groups per molecule. The epoxy resin also typically has a relatively low dynamic viscosity, such as from about 1 centipoise to about 25 centipoise, in some embodiments 2 centipoise to about 20 centipoise, and in some embodiments, from about 5 centipoise to about 15 centipoise, as determined in accordance with ASTM D445-15 at a temperature of 25° C. At room temperature (25° C.), the epoxy resin is also typically a solid or semi-solid material having a melting point of from about 50° C. to about 120° C., in some embodiments from about 60° C. to about 110° C., and in some embodiments, from about 70° C. to about 100° C. The epoxy resin can be saturated or unsaturated, linear or branched, aliphatic, cycloaliphatic, aromatic or heterocyclic, and may bear substituents which do not materially interfere with the reaction with the oxirane. Suitable epoxy resins include, for instance, glycidyl ethers (e.g., diglycidyl ether) that are prepared by reacting an epichlorohydrin with a hydroxyl compound containing at least 1.5 aromatic hydroxyl groups, optionally under alkaline reaction conditions. Multi-functional compounds are particularly suitable. For instance, the epoxy resin may be a diglycidyl ether of a dihydric phenol, diglycidyl ether of a hydrogenated dihydric phenol, triglycidyl ether of a trihydric phenol, triglycidyl ether of a hydrogenated trihydric phenol, etc. Diglycidyl ethers of dihydric phenols may be formed, for example, by reacting an epihalohydrin with a dihydric phenol. Examples of suitable dihydric phenols include, for instance, 2,2-bis(4-hydroxyphenyl) propane (“bisphenol A”); 2,2-bis 4-hydroxy-3-tert-butylphenyl) propane; 1,1-bis(4-hydroxyphenyl) ethane; 1,1-bis(4-hydroxyphenyl) isobutane; bis(2-hydroxy-1-naphthyl) methane; 1,5 dihydroxynaphthalene; 1,1-bis(4-hydroxy-3-alkylphenyl) ethane, etc. Suitable dihydric phenols can also be obtained from the reaction of phenol with aldehydes, such as formaldehyde) (“bisphenol F”). Commercially available examples of such multi-functional epoxy resins may include EPON™ resins available from Hexion under the designations 862, 828, 826, 825, 1001, 1002, 1009, SU3, 154, 1031, 1050, 133, and 165. Other suitable multi-functional epoxy resins are available from Huntsman under the trade designation Araldite™ (e.g., Araldite™ ECN 1273 and Araldite™ ECN 1299.

The adhesive coating(s) may optionally comprise further additives and/or auxiliaries as are known in the prior art, such as activators, rheology modifiers, foaming agents, fillers, plasticizers, crosslinkers, flame retardants, UV stabilizers, antioxidants, adhesion promoters, etc. Activators (or curing agents) are generally compounds that can initiate or accelerate a polymerization or crosslinking reaction, or which are able to participate as a reaction partner with the reactive resin. For reactive resins based on acrylates or methacrylates, for instance, suitable activators may include free radical compounds, such as peroxides, hydroperoxides, and azo compounds. For reactive resins based on epoxides, suitable activators may include aminic, thiolic, or acidic compounds, such as aliphatic amines (e.g., dicyandiamide), aromatic amines, modified amines, polyamide resins, acid anhydrides, secondary amines, mercaptans (e.g., polymercaptans), polysulfides, dicyandiamide, and organic acid hydrazides.

A variety of techniques may be employed to form the adhesive coating(s). In one embodiment, for instance, the components of the adhesive coating(s) (e.g., thermoplastic polymers, reactive resins, and activators) are converted into a flowable state. This may be accomplished by dissolving the components in one or more solvents and mixed to provide a homogeneous, liquid adhesive. This may be optionally accomplished with exposure to heat and/or shearing. Suitable solvents are known in the prior art, and solvents preferably used are those in which at least one of the ingredients has a good solubility. Particularly preferred are butanone or acetone. The total solids content of the liquid adhesive obtained after contact with solvent(s) is typically in the range of from about 5 wt. % to about 90 wt. %, in some embodiments from about 20 wt. % to about 80 wt. %, and in some embodiments, from about 40 wt. % to about 70 wt. % of the mixture. Alternatively, the flowable state may be achieve without the use of solvents, particularly if the ingredients are already soluble or miscible in one another (optionally with exposure to heat and/or shearing). Regardless of the manner in which it is formed, the flowable adhesive may be disposed into contact with a surface of the substrate. Techniques for contacting the flowable adhesive with the substrate may include coating, impregnation, casting, etc. Once applied, the adhesive may be solidified by heating to remove any solvent(s) or by simply allowing the adhesive to cool if it was rendered flowable due to a temperature increase. If desired, the adhesive coating may also be subjected to preliminary crosslinking (or curing) by radiation or chemical reaction at elevated temperature to improve the technical adhesive properties in the uncured state and prevent it from flowing out of the substrate when a pressure is applied.

III. Applications

The tape may be bonded to the molded component to form a laminate structure in a variety of ways, such as by the application of pressure, heat, etc. For instance, a surface of the molded component may be placed into contact with an adhesive coating of the tape. Once in contact, the molded component and tape may be subjected to a compression pressure for a period of time, such as from 1 second to 10 minutes. During and/or after the application of pressure, the laminate may be heated at an elevated temperature to initiate a polymerization and/or crosslinking reaction in the adhesive coating to cure the adhesive. Curing may occur at a temperature of from about 100° C. to about 260° C., in some embodiments from about 120° C. to about 250° C., and in some embodiments, from about 150° C. to about 240° C. (e.g., about 230° C.). Alternatively, curing may be accomplished via radiation induction, such as with UV light or a light flash.

As indicated above, the tape may optionally contain an adhesive coating on an opposing surface of the substrate. In this manner, one adhesive coating (e.g., the first adhesive coating) may be bonded to the molded component and the other adhesive coating (e.g., the second adhesive coating) may be bonded to a separate component such that the laminate structure contains the molded component, tape, and separate component. In such embodiments, the laminate structure may be bonded together simultaneously in a manner as described above, or the components may be bonded to the tape in successive steps. The nature of the separate component bonded to the tape may vary depending on the intended application. For instance, the separate component may be part of an electronic device, such as the housing, cover (e.g., antenna cover, battery cover, etc.), support structure, optical device, camera, speaker, etc. The electronic device may, for instance, be a desktop computer, portable computer, handheld electronic device, camera module, automotive equipment, etc. Examples of suitable portable electronic devices include cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, etc.

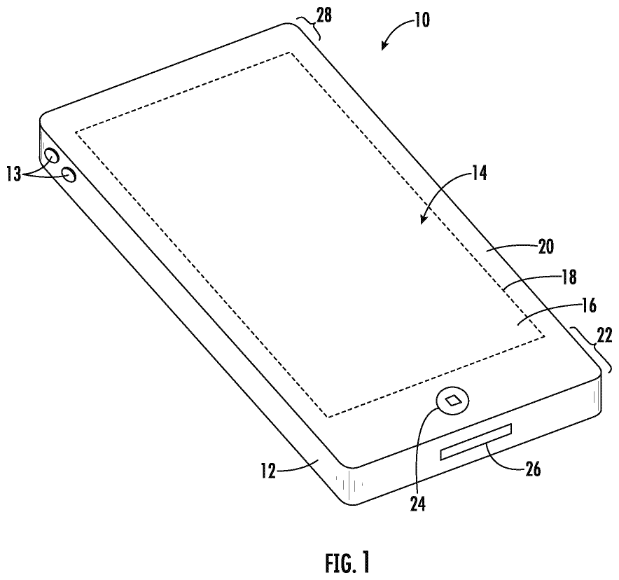

Referring to FIG. 1, for instance, one embodiment of a handheld electronic device is shown in more detail. The device includes a housing 12, which may be formed from plastic, metal, fiber composites, such as carbon fiber, glass, ceramic, other materials, and combinations of these materials. The housing 12 may be formed using a monolithic construction in which the housing 12 is formed from an integrated piece of material or may be formed from frame structures, housing walls, and other components that are attached to each other using fasteners, adhesives, and other attachment mechanisms. Ports, such as port 26, may receive mating connectors (e.g., an audio plug, a connector associated with a data cable, etc.). The device 10 may also contain buttons, such as buttons 13 mounted in the housing 12 (e.g., in a housing sidewall) and a button 24 mounted on the front face of device 10 (e.g., to serve as a menu button).

The device 10 also includes a display 14, such as a liquid crystal display (LCD), plasma display, organic light-emitting diode (OLED) display, electronic ink display, or a display implemented using other display technologies. The display 14 may contain multiple layers. For example, the display 14 may contain a backlight unit, optical films such as polarizers and birefringent films, a touch sensor array, a thin-film transistor layer, and a color filter array layer. Regardless, the outermost layer of the display 14 may be formed from one of these display layers (e.g., a color filter array layer or a polarizer layer) or may be formed from a protective cover layer. A protective cover layer for the display 14 may, for example, be formed from a transparent cover plate, such as a clear plastic plate or a layer of glass (sometimes referred to as a cover glass, cover glass layer, or cover glass plate). In the embodiment shown in FIG. 1, the display 14 has an outermost layer (e.g., cover glass layer) that extends over the front surface of device 10. The central portion of display 14 may contain active image pixels for forming an image and may therefore sometimes be referred to as the “active region” of the display. The surrounding portions of the display 14 do not contain active image pixels and are therefore sometimes said to form an “inactive region” of the display. In the example of FIG. 1, a dashed line 18 denotes the border between an interior rectangular active region 16 and a surrounding inactive region 20. The inactive region 20 has a substantially rectangular ring shape formed by left, right, top, and bottom edge regions. The active region 16 may contain conductive structures, such as touch sensor electrodes, transistors and interconnect lines associated with a thin-film transistor array or other image pixel array, etc.

Antennas are also typically located within the electronic device 10. Because conductors may impact the operation of antennas in the device 10, it may be desirable to locate the antennas at locations other than those immediately under the active region 16, such as under a top edge portion 28 of the inactive region 20 or a lower edge portion 22 of the inactive region 20. Antennas may also be formed behind other portions of the inactive display region 20 (e.g., to the left or right of active region 16). When antennas are located under the inactive display region 20, antenna signals may be transmitted and received through the inactive region 20 (e.g., upper rectangular region 28 at the top end of device 10 or the lower rectangular region 22 at the lower end of device 10) and need not be conveyed through conductive structures, such as conductive sidewalls and conductive planar rear wall structures in the housing 12. If desired, the device 10 may contain other planar dielectric structures. For example, the rear surface of device 10 (i.e., the surface opposing the front side that contains display 14) may be formed from a planar dielectric structure (e.g., a glass plate, a ceramic plate, etc.). Antennas may be formed under this type of rear plate or under other dielectric device structures.

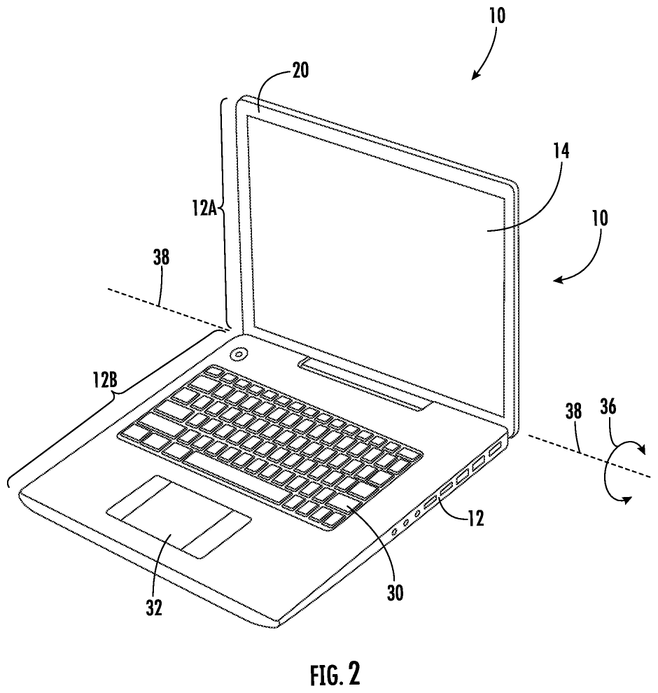

FIG. 2 illustrates another embodiment of an electronic device 10 as a portable computer or other device that has a two-part housing formed from an upper housing 12A and a lower housing 12B. The housings 12A and 12B may be connected to each other using a hinge (e.g., a hinge located along the upper edge of lower housing 12B and the lower edge of upper housing 12A). The hinge may allow the upper housing 12A to rotate about an axis 38 in directions 36 relative to the lower housing 12B. The device 10 may also include input-output components, such as a keyboard 30 and a track pad 32. The upper housing 12A may include a display 14 surrounded by inactive regions 20, which may be associated with portions of a cover layer (e.g., glass cover) that does not have underlying active image pixel elements. Similar to the embodiment discussed above and shown in FIG. 1, antennas may be formed under the inactive display portions 20 or other planar dielectric structures in device 10 of FIG. 2 (e.g., dielectric plates such as glass plates that are formed as part of housing 12, etc.).

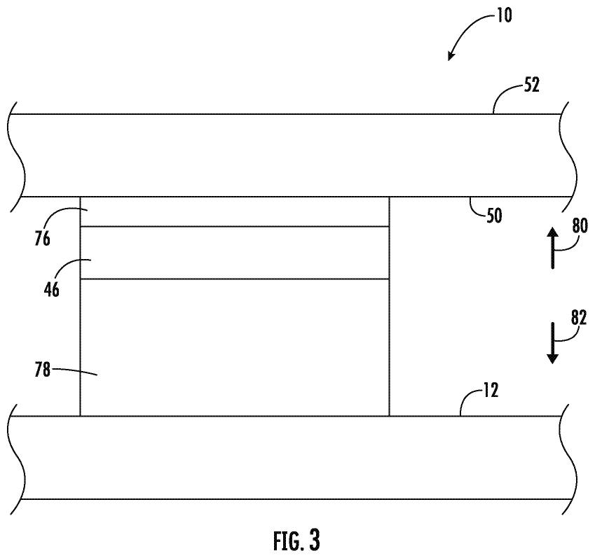

Regardless of the particular nature and configuration of the electronic device, the antenna structures referenced above may employ the molded component/tape configuration of the present invention to help securely position the antennas in the desired location. In this regard, such an antenna structure may include the tape that bonds together the molded component on which one or more antenna elements are formed and another component of the electronic device, such as the cover (e.g., glass cover) or housing. Referring to FIG. 3, for example, one embodiment of such a structure is shown in more detail. As shown, the device 10 contains an antenna structure 46, which includes the molded component and one or more resonating antenna element formed thereon, such as by laser direct structuring. The antenna structure 46 is bonded to a surface 50 of an electronic component 52 using a tape 76, which contains a first adhesive coating in contact with the antenna structure 46 and a second adhesive coating in contact with the electronic component 52. If desired, optional biasing and/or support structures 78 may also be employed. Support structures may include, for instance, dielectric supports formed from rigid plastic, flexible plastic (e.g., soft plastic such as polytetrafluoroethylene), glass, ceramic, etc. The support structures function as a a spacer to separate the antenna structure 46 from the housing 12 (which may form a ground element for the antenna). The biasing structures may include layers of foam, rubber, or other compressible substances, coil springs, leaf springs, other spring structures, etc. Such structures may be compressed between the antenna structure 46 and the and housing 12 (or structures mounted on housing 12) to create a restoring force that presses downwards in a direction 82 against the housing 12 (or other underlying structures in device 10) and that presses upwards in a direction 82. The upwards (outwards) pressure in the direction 80 helps press the antenna structure 46 against the tape 76, thereby helping to attach it securely against the lower (interior) surface 50.

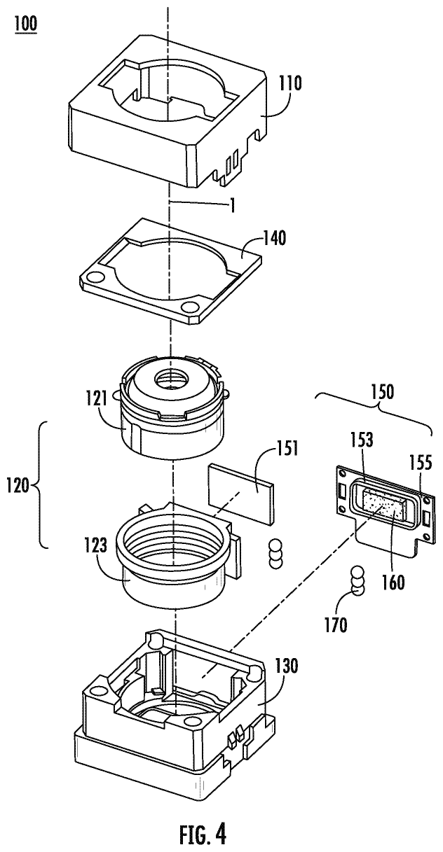

Of course, it should be understood that the present invention is by no means limited to embodiments in which antenna elements are employed. In other embodiments, for example, the laminate structure of the present invention may be employed in a camera module. Referring to FIG. 4, for example, one embodiment of a camera module 100 is shown that contains a lens module 120 that is contained within a housing, wherein the lens module 120 contains a lens barrel 121 coupled to a lens holder 123. The lens barrel 121 may have a hollow cylindrical shape so that a plurality of lenses for imaging an object may be accommodated therein in an optical axis direction 1. The lens barrel 121 may be inserted into a hollow cavity provided in the lens holder 123, and the lens barrel 121 and the lens holder 123 may be coupled to each other by a fastener (e.g., screw), adhesive, etc. The lens module 120, including the lens barrel 121, may be moveable in in the optical axis direction 1 (e.g., for auto-focusing) by an actuator assembly 150. In the illustrated embodiment, for example, the actuator assembly 150 may include a magnetic body 151 and a coil 153 configured to move the lens module 120 in the optical axis direction 1. The magnetic body 151 may be mounted on one side of the lens holder 123, and the coil 153 may be disposed to face the magnetic body 151. The coil 153 may be mounted on a substrate 155, which is in turn may be mounted to the housing 130 so that the coil 153 faces the magnetic body 151. The actuator assembly 150 may include a drive device 160 that is mounted on the substrate 155 and that outputs a signal (e.g., current) for driving the actuator assembly 150 depending on a control input signal. The actuator assembly 150 may receive the signal and generate a driving force that moves the lens module 120 in the optical axis direction 1. If desired, a stopper 140 may also be mounted on the housing 130 to limit a moving distance of the lens module 120 in the optical axis direction 1. Further, a shield case 110 (e.g., metal) may also be coupled to the housing 130 to enclose outer surfaces of the housing 130, and thus block electromagnetic waves generated during driving of the camera module 100. If desired, ball bearings 170 may act as a guide unit of the actuator assembly 150. More specifically, the ball bearings 170 may contact an outer surface of the lens holder 123 and an inner surface of the housing 130 to guide the movement of the lens module 120 in the optical axis direction 1. That is, the ball bearings 170 may be disposed between the lens holder 123 and the housing 130, and may guide the movement of the lens module 120 in the optical axis direction through a rolling motion.

The laminate structure of the present invention may be employed in any of a variety of parts of the camera module 100. In one embodiment, for example, the housing 130 may be formed from the molded component described above, and the tape may be used to bond the housing 130 to the shield case 110. Alternatively, the substrate 155 may be formed from the molded component described above, and the tape be used to bond the substrate 155 to the drive device 160.

The present invention may be better understood with reference to the following examples.

### Test Methods

Peel Strength and Peak Strength: The peel strength and peak strength may be determined in accordance with ASTM D3167-10 (2017), which tests the strength needed to peel a specimen at an 180° angle (e.g., with Instru-met/MTS Insight Renew using Testworks 4 software). The test speed is 6 inches per minute and the peel strength values may be determined for distances between 0.5 and 4.5 inches. The “peel strength” is the average peel strength of the sample over the peel distances noted above and the “peak strength” is the peak peel strength observed over the peel distances noted above. The test laminate structure may be prepared by bonding an injection molded sample (8 inches×2 inches×0.5 inches) to an adhesive tape. The adhesive tape may, for instance, be HAF® 58473, which is a reactive, heat-activated film based on phenolic resin and nitrile rubber that is commercially available from tesa SE. To bond the molded sample to the tape, the tape is initially placed on the molded sample and pressed together at 110° C. and 5 bar for 10 seconds to form a pre-laminate structure. The pre-laminate structure is further pressed at 180° C. and 10 bar for 180 seconds and thereafter finally cured at 230° C. for 60 minutes.

Melt Viscosity: The melt viscosity (Pa-s) may be determined in accordance with ISO Test No. 11443:2014 at a shear rate of 1,000 s⁻¹ and temperature 15° C. above the melting temperature (e.g., about 335° C.) using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-2:2020. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO Test No. 75-2:2013 (technically equivalent to ASTM D648-07). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO Test No. 527:2019 (technically equivalent to ASTM D638-14). Modulus and strength measurements may be made on the same test strip sample having a length of 80 mm, thickness of 10 mm, and width of 4 mm. The testing temperature may be about 23° C., and the testing speeds may be 1 or 5 mm/min.

Flexural Modulus, Flexural Stress, and Flexural Elongation: Flexural properties may be tested according to ISO Test No. 178:2019 (technically equivalent to ASTM D790-10). This test may be performed on a 64 mm support span. Tests may be run on the center portions of uncut ISO 3167 multi-purpose bars. The testing temperature may be about 23° C. and the testing speed may be 2 mm/min.

Unnotched and Notched Charpy Impact Strength: Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be about 23° C.

### Example 1

Samples 1-5 are formed from various combinations of a liquid crystalline polymer (LCP 1), copper chromite (CuCr₂O₄), compatibilizer (Elvaloy® PTW—epoxy-functionalized olefin terpolymer formed from ethylene, butyl acrylate, and glycidyl methacrylate), wollastonite fibers (Nyglos® 4W or Nyglos® 8), calcium pyrophosphate, barium sulfate, calcium sulfate, and a lubricant (Glycolub® P). LCP 1 is formed from 60% HBA, 5% HNA, 17.5% TA, 12.5% BP, and 5% APAP. Compounding was performed using a 32-mm twin screw extruder. Parts are injection molded into ISO standard bars and plaques (8 inches×2 inches×0.5 inches).

TABLE 1

| | 1 | 2 | 3 | 4 | 5 |
|---|---|---|---|---|---|
| LCP 1 | 63.1 | 58.1 | 58.1 | 58.1 | 58.1 |
| Copper Chromite | 6.6 | 6.6 | 6.6 | 6.6 | 6.6 |
| Glycolube ® P | 0.3 | 0.3 | 0.3 | 0.3 | 0.3 |
| Compatibilizer | — | — | 1 | 4 | — |
| Wollastonite Fibers | 30 | — | — | — | 10 |
| Calcium Pyrophosphate | — | 35 | — | — | — |
| Barium Sulfate | — | — | 35 | 35 | — |
| Calcium Sulfate | — | — | — | — | 20 |

Samples 1-5 were tested for thermal and mechanical properties. The results are set forth below in Table 2.

TABLE 2

| Sample | 1 | 2 | 3 | 4 | 5 |
|---|---|---|---|---|---|
| Peel Strength (lbf/in) | 0.525 | 0.387 | 0.289 | 0.369 | 0.369 |
| Peak Strength (lbf/in) | 1.162 | 0.827 | 0.586 | 0.874 | 0.565 |
| DTUL at 1.8 MPa (° C.) | 248 | 224 | 225 | 218 | 229 |
| Charpy Notched (kJ/m²) | 16 | 6.5 | 19 | 14 | 7.3 |
| Charpy Unnotched (kJ/m²) | 57 | 48 | 55 | 57 | 40 |
| Tensile Strength (MPa) | 137 | 109 | 122 | 113 | 122 |
| Tensile Modulus (MPa) | 15,663 | 9,557 | 8,777 | 7,713 | 10,769 |
| Tensile Elongation (%) | 1.96 | 3.87 | 4.04 | 4.54 | 2.58 |
| Flexural Strength (MPa) | 171 | 126 | 124 | 108 | 142 |
| Flexural Modulus (MPa) | 13,897 | 9,006 | 8,299 | 7,481 | 10,014 |
| Flexural Elongation (%) | 3.04 | >3.5 | >3.5 | >35 | >3,5 |
| Melt Viscosity (Pa-s) at | 46.9 | 47.5 | 26.6 | 39.6 | 30.1 |
| 1,000 s⁻¹ | | | | | |
| Melting Temperature | 339 | 330 | 341 | 334 | 333 |
| (° C., 1^{st} heat of DSC) | | | | | |

### Example 2

Samples 2-6 are formed from various combinations of liquid crystalline polymers (LCP 1 and LCP 2), copper chromite (CuCr₂O₄), compatibilizer (Elvaloy® PTW—epoxy-functionalized olefin terpolymer formed from ethylene, butyl acrylate, and glycidyl methacrylate), wollastonite fibers (Nyglos® 4W or Nyglos® 8), calcium pyrophosphate, barium sulfate, calcium sulfate, and a lubricant (Glycolub® P). LCP 1 is formed from 60% HBA, 5% HNA, 17.5% TA, 12.5% BP, and 5% APAP. LCP 2 is formed from 79.7% HBA, 20% HNA, and 0.7% TA. Compounding was performed using a 32-mm twin screw extruder. Parts are injection molded into ISO standard bars and plaques (8 inches×2 inches×0.5 inches).

TABLE 3

| | 6 | 7 | 8 | 9 | 10 |
|---|---|---|---|---|---|
| LCP 2 | 47.7 | 42.7 | 41.7 | 38.7 | 47.7 |
| LCP 1 | 15.4 | 15.4 | 15.4 | 15.4 | 15.4 |
| Copper Chromite | 6.6 | 6.6 | 6.6 | 6.6 | 6.6 |
| Glycolube ® P | 0.3 | 0.3 | 0.3 | 0.3 | 0.3 |
| Compatibilizer | — | — | 1 | 4 | — |
| Wollastonite Fibers | 30 | — | — | — | 10 |
| Calcium Pyrophosphate | — | 35 | — | — | — |
| Barium Sulfate | — | — | 35 | 35 | — |
| Calcium Sulfate | — | — | — | — | 20 |

Samples 6-10 were tested for thermal and mechanical properties. The results are set forth below in Table 4.

TABLE 4

| Sample | 6 | 7 | 8 | 9 | 10 |
|---|---|---|---|---|---|
| Peel Strength (lbf/in) | 0.687 | 0.811 | 0.720 | 0.882 | 0.851 |
| Peak Strength (lbf/in) | 0.995 | 1.169 | 0.856 | 1.211 | 1.111 |
| DTUL at 1.8 MPa (° C.) | 223 | 201 | 198 | 196 | 197 |
| Charpy Notched (kJ/m²) | 22.0 | 4.9 | 15.5 | 11.0 | 13.0 |
| Charpy Unnotched (kJ/m²) | 43 | 37 | 39 | 44 | 37 |
| Tensile Strength (MPa) | 161 | 115 | 132 | 119 | 132 |
| Tensile Modulus (MPa) | 16,552 | 9,523 | 8,699 | 7,995 | 11,334 |
| Tensile Elongation (%) | 3.7 | 5.1 | 5.7 | 5.3 | 3.6 |
| Flexural Strength (MPa) | 196 | 139 | 136 | 118 | 160 |
| Flexural Modulus (MPa) | 14,938 | 9,374 | 8,617 | 7,764 | 10,992 |
| Flexural Elongation (%) | 3.3 | >3.5 | >3.5 | >3.5 | >3.5 |
| Melt Viscosity (Pa-s) at | 46.5 | 67.9 | 39.4 | 65.3 | 46.4 |
| 1,000 s⁻¹ | | | | | |
| Melting Temperature | 319 | 319 | 316 | 319 | 318 |
| (° C., 1^{st} heat of DSC) | | | | | |

### Example 3

Samples 11-14 are formed from various combinations of liquid crystalline polymers (LCP 1, LCP 2, and LCP 3), copper chromite (CuCr₂O₄), compatibilizer (Elvaloy® PTW—epoxy-functionalized olefin terpolymer formed from ethylene, butyl acrylate, and glycidyl methacrylate), wollastonite fibers (Nyglos® 4W or Nyglos® 8), barium sulfate, and a lubricant (Glycolub® P). LCP 1 is formed from 60% HBA, 5% HNA, 17.5% TA, 12.5% BP, and 5% APAP. LCP 2 is formed from 79.7% HBA, 20% HNA, and 0.7% TA. LCP 3 is formed from 43% HBA, 20% NDA, 9% TA, and 28% HQ. Compounding was performed using a 32-mm twin screw extruder. Parts are injection molded into ISO standard bars and plaques (8 inches×2 inches×0.5 inches).

TABLE 5

| | 11 | 12 | 13 | 14 |
|---|---|---|---|---|
| LCP 2 | — | 38.7 | — | — |
| LCP 3 | | | 43.7 | 43.7 |
| LCP 1 | 59.1 | 15.4 | 15.4 | 15.4 |
| Copper Chromite | 6.6 | 6.6 | 6.6 | 6.6 |
| Glycolube ® P | 0.3 | 0.3 | 0.3 | 0.3 |
| Compatibilizer | 4 | 4 | 4 | 4 |
| Wollastonite Fibers | 30 | — | 30 | — |
| Barium Sulfate | — | 35 | — | 35 |

Samples 11-14 were tested for thermal and mechanical properties. The results are set forth below in Table 6.

TABLE 6

| Sample | 11 | 12 | 13 | 14 |
|---|---|---|---|---|
| Peel Strength (lbf/in) | 1.696 | 4.273 | 1.426 | 1.826 |
| Peak Strength (lbf/in) | 2.656 | 5.588 | 2.731 | 2.708 |
| Melt Viscosity (Pa-s) at 1,000 s⁻¹ | 29.9 | 57.4 | 51.7 | 51.2 |
| Melting Temperature | 332 | 318 | 305 | 299 |
| (° C., 1^{st} heat of DSC) | | | | |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A laminate structure comprising:
a tape that comprises a substrate having a first surface and an opposing second surface, wherein a first adhesive coating is disposed on the first surface of the substrate; and
a molded component that is positioned adjacent and bonded to the first adhesive coating of the tape, wherein the molded component includes a polymer composition that contains a liquid crystalline polymer;
wherein the peel strength between the tape and the molded component is about 0.55 pounds-force per inch more as determined in accordance with ASTM D3167-10 (2017).

2. The laminate structure of claim 1, wherein the polymer composition has a melting temperature of from about 200° C. to about 400° C. and a deflection temperature under load of from about 170° C. to about 280° C. as determined in accordance with ISO Test No. 75-2:2013 at a load of 1.8 MPa.

3. The laminate structure of claim 1, wherein the liquid crystalline polymer contains repeating units derived from one or more aromatic hydroxycarboxylic acids.

4. The laminate structure of claim 3, wherein the aromatic hydroxycarboxylic acids include 4-hydroxybenzoic acid, 6-hydroxy-2-naphthoic acid, or a combination thereof.

5. The laminate structure of claim 4, wherein the liquid crystalline polymer contains repeating units derived from 6-hydroxy-2-naphthoic acid in an amount of about 5 mol. % or more.

6. The laminate structure of claim 4, wherein the liquid crystalline polymer contains repeating units derived from 4-hydroxybenzoic acid in an amount of from about 50 mol. % to about 95 mol. %.

7. The laminate structure of claim 4, wherein the liquid crystalline polymer contains repeating units derived from 4-hydroxybenzoic acid and 6-hydroxy-2-naphthoic acid in a molar ratio of from about 0.5 to about 20.

8. The laminate structure of claim 3, wherein the liquid crystalline polymer further contains repeating units derived from one or more aromatic dicarboxylic acids, one or more aromatic diols, or a combination thereof.

9. The laminate structure of claim 8, wherein the amount of repeating units derived from aromatic dicarboxylic acids and/or aromatic diols is about 5 mol. % or less.

10. The laminate structure of claim 1, wherein the liquid crystalline polymer is wholly aromatic.

11. The laminate structure of claim 1, wherein liquid crystalline polymers constitute from about 40 wt. % to about 90 wt. % of the polymer composition.

12. The laminate structure of claim 1, wherein the polymer composition further comprises an epoxy-functionalized olefin copolymer.

13. The laminate structure of claim 1, wherein the polymer composition further comprises a mineral filler.

14. The laminate structure of claim 13, wherein the mineral filler includes mineral particles.

15. The laminate structure of claim 13, wherein the mineral filler includes mineral fibers.

16. The laminate structure of claim 1, wherein the polymer composition further contains a laser activatable additive.

17. The laminate structure of claim 16, wherein the laser activatable additive includes oxide crystals.

18. The laminate structure of claim 17, wherein the oxide crystals include MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, (Sb/Sn)O₂, or a combination thereof.

19. The laminate structure of claim 1, wherein at least one antenna element is formed on the molded component.

20. The laminate structure of claim 19, wherein the antenna element has a feature size that is less than about 1,500 micrometers.

21. The laminate structure of claim 19, wherein a plurality of antenna elements are formed on the molded component in an antenna array.

22. The laminate structure of claim 21, wherein the antenna elements are spaced apart by a spacing distance that is less than about 1,500 micrometers.

23. The laminate structure of claim 21, wherein the antenna array has an average antenna element concentration of greater than 1,000 antenna elements per square centimeter.

24. The laminate structure of claim 1, wherein the substrate includes a film, paper web, nonwoven web, foam, or a combination thereof.

25. The laminate structure of claim 1, wherein the first adhesive coating is a pressure-sensitive, hot-melt adhesive.

26. The laminate structure of claim 1, wherein the first adhesive coating includes an elastomeric thermoplastic polymer.

27. The laminate structure of claim 26, wherein the elastomeric thermoplastic polymer has a glass transition temperature of from about −40° C. to about 10° C.

28. The laminate structure of claim 26, wherein the elastomeric thermoplastic polymer includes an acrylonitrile/butadiene copolymer.

29. The laminate structure of claim 26, wherein the first adhesive coating is formed from a mixture containing the elastomeric thermoplastic polymer and a reactive resin.

30. The laminate structure of claim 29, wherein the reactive resin includes an epoxy resin.

31. The laminate structure of claim 29, wherein the mixture further contains an activator.

32. The laminate structure of claim 29, wherein the tape further comprises a second adhesive coating that is disposed on the second surface of the substrate.

33. The laminate structure of claim 32, wherein a separate component is positioned adjacent and bonded to the second adhesive coating of the tape.

34. The laminate structure of claim 33, wherein the separate component is a component of an electronic device.

35. The laminate structure of claim 34, wherein the separate component is a housing, cover, or a combination thereof.

36. An electronic device comprising the laminate structure of claim 1.

37. The electronic device of claim 36, wherein the electronic device is a portable electronic device.

38. The electronic device of claim 36, wherein the electronic device includes a camera module.

39. A method for forming the laminate structure of claim 1, the method comprising:
placing the molded component into contact with the first adhesive coating to form a laminate; and
heating the laminate to a temperature of from about 100° C. to about 260° C. to cure the adhesive coating.

40. The method of claim 39, wherein heating occurs while a compression pressure is applied to the laminate.
